(19) United States
(12) Patent Application Publication
(10) Pub. No.: US 2022/0298406 A1
(43) Pub. Date: Sep. 22, 2022

(54) Method of Using Alginates in Subterranean Wellbores

(71) Applicant: Newpark Drilling Fluids, LLC, Katy, TX (US)

(72) Inventors: Ahmed Amer, Katy, TX (US); Matthew Lynn Miller, Houston, TX (US)

(21) Appl. No.: 17/760,717

(22) PCT Filed: Sep. 21, 2020
(86) PCT No.: PCT/US2020/051818

§ 371 Date: Mar. 15, 2022

Related U.S. Application Data
(60) Provisional application No. 62/902,917, filed on Sep. 19, 2019.

(51) Int. Cl. C09K 8/512; C09K 8/516; C09K 8/44; C09K 8/514

(52) U.S. Cl. CPC C09K 8/512; C09K 8/516; C09K 8/44; C09K 8/514; C09K 2208/26

(57) ABSTRACT

Fluid loss from a wellbore into a subterranean formation may be reduced by forming a fluid barrier of a crosslinked alginate.

### BACKGROUND

Drilling of most oil and gas wells includes the use of a drilling fluid, commonly known as drilling mud. The fluid is pumped under pressure through the drill string during drilling and returns to the surface through the drill string-borehole annulus. Once returned to the surface, the drilling fluid contains cuttings from the drill bit. Although most large cuttings are removed at the surface prior to recirculating the fluid, smaller sized particles remain suspended within the drilling fluid.

In addition to the removal of drilled cuttings from the wellbore, drilling fluids perform other functions. Such functions include cooling of the drill bit, lubrication of the drill bit, optimizing the transmission of hydraulic energy to the drill bit, increasing the stability of the borehole and providing hydrostatic pressure to prevent the collapse of high pressure geologic zones when such zones are penetrated by the drill bit.

Loss of fluids in the wellbore into permeable and/or fractured regions of formations (including shale, sand, gravel, limestone, dolomite and chalk) or fissured, highly permeable, porous, cavernous or vugular is a common problem. Such fluid loss can dramatically increase operating costs. For instance, loss of drilling fluids into the formation can cause damage to the drill bit, reduce drilling rates as well as cause blowouts from fluid level drops in the well. Excessive loses of brine into production zones of the formation during completion operations lead to well control issues as well as wellbore damage.

Various methods have been used to mitigate fluid loss. One method is the use of lost circulation materials (LCMs) or loss circulation pills (fluid loss pills) which seal or block ports of entry of fluids into the formation. These are effective in drilling muds provided flow passages are plugged quickly. In completion and workover operations, fluid loss pills form an impermeable barrier which blocks production zones from the area undergoing the completion or workover operation.

Common LCMs include fibrous materials, such as cedar bark, mineral fiber and hair and granular materials, such as limestone, marble, wood, and nut hulls, cellulosic polysaccharides, like hydroxyethyl cellulose (HEC), which function by enhancing filter-cake buildup on the face of the formation. However, their use is limited to low temperature zones below about 150° F. to about 200° F. At elevated temperatures, as well as under high shear, these polymers tend to break down. In addition, they exhibit incompatibility with some divalent heavy brines and may increase permeability damage with increasing penetration of the pill.

There exists a continuing need to reduce the loss of fluids into flow passages of a formation during hydrocarbon recovery operations, such as drilling, cementing, completion and workover.

### SUMMARY

An embodiment of the disclosure is drawn to a method of forming a fluid barrier from a wellbore into a subterranean formation with a crosslinked alginate. Fluid loss is reduced from the wellbore into subterranean formation.

Another embodiment is drawn to a method for preventing or reducing loss of fluids into flow passages of a subterranean formation penetrated by a well during drilling, completion, cementing or a workover operation. In this method, the flow passages are blocked with a gel comprising the crosslinked alginate.

Another embodiment is drawn to a method of first enhancing viscosity of a crosslinked reaction product of alginic acid or sodium alginate and a calcium containing crosslinking agent in-situ to form a loss circulation material. Loss of fluid into flow passages of the formation are reduced with the lost circulation material.

Another embodiment is drawn to a method wherein separate streams of alginic acid and/or sodium alginate and a water soluble alkaline earth containing crosslinking agent are first pumped into a well penetrating a subterranean formation. A viscous gel is formed from the reaction of the alginic acid or sodium alginate with the crosslinking agent. A fluid-impermeable barrier is formed on the surface of the formation with the viscous gel. Permeability of the formation is thereby reduced, loss of fluid into the formation is mitigated and/or fluid communication within the wellbore is thereby reduced.

### DETAILED DESCRIPTION

The following description provides specific details, such as compositions, methods and conditions in order to provide a thorough description of embodiments of the disclosure. However, a person of ordinary skill in the art will understand that the embodiments described herein may be practiced without employing these specific details. For instance, the embodiments of the disclosure may be practiced in conjunction with conventional techniques employed in the industry.

As used herein and throughout various portions of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function.

Also, the terms “including” and “comprising” are used herein and in the appended claims in an open-ended fashion, and thus should be interpreted to mean “including, but not limited to . . . .”

The suffix “(s)” as used herein is intended to include both the singular and the plural of the term that it modifies, thereby including at least one of that term. Reference herein and in the appended claims to components and aspects in a singular tense does not necessarily limit the present disclosure or appended claims to only one such component or aspect, but should be interpreted generally to mean one or more, as may be suitable and desirable in each particular instance. The use of the terms “a” and “an” and “the” and similar variants in the context of describing the embodiments (especially in the context of the following claims) are to be construed to cover both the singular and the plural, unless otherwise indicated herein or clearly contradicted by context.

All ranges disclosed herein are inclusive of the endpoints. A numerical range having a lower endpoint and an upper endpoint shall further encompass any number and any range falling within the lower endpoint and the upper endpoint. For example, every range of values (in the form “from a to b” or “from about a to about b” or “from about a to b” and any similar expressions, where “a” and “b” represent numerical values of degree or measurement is to be understood to set forth every number and range encompassed within the broader range of values and inclusive of the endpoints.

Drilling fluid is continuously pumped from the surface into the wellbore during drilling to maintain hydrostatic pressure within the wellbore, to remove and transport drill cuttings from the wellbore to the surface, to lubricate the drill bit, and to perform other operations, such as transferring hydraulic energy to the drill bit or other downhole components. Traditionally, drilling fluid is pumped from a mud pit at the surface into the wellbore and returns to the surface. Fluid loss or a lost circulation zone occurs when fluid is lost from the wellbore into the formation. Methods of determining fluid losses or a lost circulation zone are well known and include determining a pressure drop in the wellbore and measuring less flow rate of drilling fluid returning to the surface than being pumped into the wellbore.

The present disclosure includes compositions for use as lost circulation materials (LCM) to mitigate or prevent such lost circulation in the wellbore and prevent or reduce the loss of drilling fluid into the formation. The compositions described in this disclosure may block or create a solid plug in a fracture of a formation to reduce or prevent the loss of the drilling fluid into the surrounding formation.

Alginates can be used to deliver a LCM that can be effective in stopping, mitigating or minimizing passage of wellbore fluids into subterranean formations. Alginate is a polysaccharide derived from and/or present within the cell walls of phaeophyceae, such as brown algae. Typically, the alginate present in these cell walls is in the form of an alginate salt, such as calcium, magnesium and sodium salts of alginic acid. A person having ordinary skill in the art will appreciate various methods of extracting alginic acid from algae. In a non-limiting example, the algae can be converted into an alginate salt by reacting with an alkali, such as sodium carbonate and precipitating the alginate, such as into an alginic acid.

Alginic acid has a chemical formula of (C6H806)_{X} where X is generally between 1 and 60. The molar mass of alginic acid can range from 10,000 to 600,000. Suitable crosslinking agents for crosslinking salts of alginic acid may be water soluble. Examples of suitable crosslinking agents include alkaline earth metals, including but not limited to calcium, magnesium, or another agent. Non-limiting examples of the crosslinking agent include calcium chloride, gypsum, lime, calcium sulfate, calcium carbonate, and dicalcium phosphate. Generally, the longer the alginate is in contact with the crosslinking agent, the more rigid the gel becomes as more crosslinks are formed.

Crosslinked alginates can be gels and not soluble in water or organic solvents. At elevated temperatures and/or over time, crosslinked alginates can form an impermeable barrier which may be rigid. Typically, the increase in viscosity of the crosslinked alginate under in-situ conditions creates the impermeable barrier. Permeability of the formation is reduced, loss of fluid into the formation is mitigated and/or fluid communication within the wellbore is reduced by the formation of the impermeable barrier.

A representative reaction schematic for producing calcium crosslinked alginate from sodium alginate may be represented as follows:

[symbol]

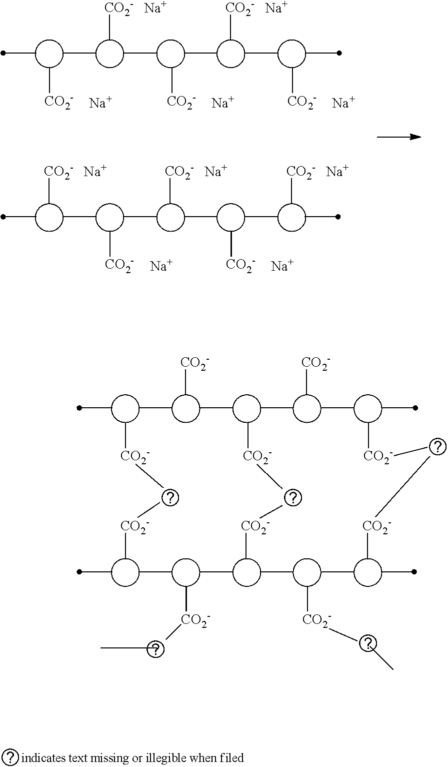

The gellant becomes more rigid and the viscoelasticity of the gum increases as sodium ions are exchanged with calcium ions. The molar ratio of calcium ions to sodium ions in sodium alginate will further govern the rigidity of the gel. For instance, where the molar ratio of sodium ions in the sodium alginate to calcium ions in the crosslinking agent is greater than 2:1, the less rigid the gel. Typically, the molar ratio of sodium to calcium ions is greater than 2:1 to form a more rigid gel.

In some instances, the LCM may be introduced into the well in a treatment fluid (such as a drilling mud). In such instances, the amount of LCM added to the fluid can range from about 1 to 20 pounds per barrel (“ppb”), or about 2 to 10 ppb, or about 4 to about 6 ppb.

In another embodiment, the crosslinked alginates may be combined with a carrier or base fluid to form a slurry which is then introduced into the well as a fluid loss pill. The fluid loss pill may be oil based or water based. In an embodiment, the fluid loss pill may be used in conjunction with drilling, completion or workover fluids which are often brines. As such, the fluid loss pill prevents these fluids from invading the formation during drilling, completion or workover.

The fluid loss pill may be a dense fluid that exhibits stable rheological properties, especially at elevated temperatures and over extended periods of time. Typically, the pill is stable and may be used at temperatures in excess of 250° F.). When used as a fluid loss pill, the well fluid is compatible with oilfield heavy brines.

The fluid loss pill may be spotted adjacent to the permeable formation by pumping a slug of the slurry down and out of the drill pipe. If the permeable formation is at a point farther up in the well bore, the drill pipe can be raised so that the slug is deposited adjacent the permeable formation. Spotting the slug adjacent to the permeable formation may be accomplished by methods known in the art.

The fluid loss pill should have a density equal to or greater than the density of the treatment fluid in order that the fluid loss pill may remain in contact with the formation wall in the wellbore and not be displaced by the treatment fluid. A sufficient amount of the LCM is thus typically added to the base fluid such that the density of the slurry is equal to or greater than the density of the treatment fluid. For example, the density of a fluid loss pill for completion should be greater than or equal to the density of a completion brine to avoid being displaced by the completion brine. In an embodiment, the density of the pill may be controlled by increasing the salt concentration in the brine (up to saturation). After being introduced into the wellbore, the slurry may be defluidized (dewatered or de-oiled) adjacent to a permeable formation to leave behind the plug or seal.

The amount of LCM materials in the slurry may depend on fluid loss levels, the anticipated fractures, the density limits for the pill in the wellbore, the duration of time the pill is needed and/or pumping limitations, etc. For example, the amount of LCM material in a slurry may range from about 10 pounds per barrel (ppb) to 50 ppb with an upper limit on most wellbore applications being 150 ppb.

Selection between an aqueous fluid and an oleaginous fluid may be dependent on the type of treatment fluid being used in the well at the time of the lost circulation event. Use of the same fluid type may reduce contamination and allow drilling to continue upon plugging of the formation fractures/fissures, etc.

Exemplary aqueous fluids may be fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. Suitable brines include halide or carboxylate salts of mono- or divalent cations of metals, such as cesium, potassium, calcium, zinc, and/or sodium.

Exemplary oleaginous fluids include natural and synthetic oils including diesel oil; mineral oil; hydrogenated and unhydrogenated olefins including polyalpha olefins, linear and branch olefins; and esters of fatty acids.

The fluid loss pill may also include one or more additives known to those of ordinary skill in the art, such as wetting agents, surfactants, dispersants, pH buffers, rheological additives, etc. The base fluid may also contain a weighting agent such that the density of the treatment fluid may be controlled in order to balance pressure requirements in the well to prevent a blowout. Weighting agents may be selected from one or more of the materials including, for example, barium sulphate (barite), calcium carbonate (calcite), dolomite, ilmenite, hematite or other iron ores, olivine, siderite, manganese oxide, and strontium sulfate. Further, the fluid may be weighted by using salt brines.

One skilled in the art would appreciate that depending on components present in the fluid, the pH of the fluid may change. In particular embodiments of the present disclosure, the pH of the fluid loss pill may be above 7.

The particle size of the crosslinked alginates may be selected depending on the level of fluid loss, formation type, and/or the size of fractures or fissures. The LCM particles may range in size from nano-scale to a macro-scale, for example, from about 100 nanometers to about 3000 microns, and preferably from about 25 microns to about 1500 microns. The size may also depend on the other particles selected for use in the LCM pill.

Alternatively, the crosslinking alginate may be formed during or after pumping the alginate salts or alginic acid and crosslinking agent into the well. When formed in-situ, separate streams are pumped into the well. For instance, in a drilling operation, the alginic acid or sodium alginate may be introduced into the well inside the drill string and the crosslinking agent may be pumped into the backside of the wellbore in the annulus. The crosslinked alginate is formed inside the well (in-situ). Crosslinking may occur upon pumping the two streams into the well. Enhanced crosslinking typically occurs at elevated temperatures within the well such that the barrier is placed at a targeted location.

When the crosslinked alginate is formed under in-situ conditions, the crosslinking agent may be encapsulated so as to delay crosslinking of the alginate down hole.

The crosslinked alginate thickens downhole and forms agglomerates which further thicken to form a gelled plug or impermeable in or near the subterranean formation, typically in a controlled period of time designed around the placement time to a targeted zone. In an embodiment, the crosslinked alginate barrier may resemble an agglomerated mass formed of small globules. The crosslinked alginate is not deposited as a solid on the formation walls.

The barrier or plug may form at the interface of the wellbore and the formation surface or within flow passages within the formation. The formation of such barriers or plugs in the wellbore or in the formation enables a reduction of loss of wellbore fluid into the formation.

After formation of the impermeable barrier, drilling, cementing, completion or workover is resumed.

In an embodiment, the crosslinked alginate may be degraded under elevated heat, by conventional gel breakers (such as oxidative or enzymatic breakers, including delayed release breakers) as well as with an acid wash (such as inorganic acids like hydrochloric acid, hydrobromic acid, nitric acid, chloric acid, sulfuric acid and hydrofluoric acid as well as organic acids such as citric acid, acetic acid, tartaric acid, formic acid and malic acid. Broken fragments of the crosslinked alginates are of a size that can easily flow back and be recovered at the wellhead. The solid-free fluid loss pill thus induces less formation damage as little or no polymer residue is left in the formation.

The gel breaker may be contacted with the crosslinked alginate after the crosslinked alginate has been pumped or formed in the formation. When the crosslinked alginate is pumped directly into the well, the gel breaker may be a component of the fluid in which it is pumped.

In an embodiment, the crosslinked alginate may be used for blocking non-productive thief zones. In such cases, a breaker would not be required since the gellant would remain as a blocking material.

The LCM and fluid loss pill exhibits a broad range of compatibility with a variety of formations and wellbore fluids such as shales, seawater, fresh formation waters, oils, completion fluids, packer fluids and spacer fluids.

### Examples

The following examples are illustrative of some of the embodiments of the disclosure. Other embodiments within the scope of the claims herein will be apparent to one skilled in the art from consideration of the description set forth herein. It is intended that the specification, together with the examples, be considered exemplary only, with the scope and spirit of the disclosure being indicated by the claims which follow.

All percentages set forth in the Examples are given in terms of weight units except as may otherwise be indicated.

Examples 1-5. About 347.8 ml of tap water was blended with 2.19 ml of sodium alginate to form a 1% solution. The solution was mixed with tap water for five minutes on a multi-mixer. This base solution was split into three different portions (115.9 ml per sample). Each portion varied in concentration of source material for calcium or used a different calcium source. Example 1 utilized 0.12 grams of gypsum, Example 2 utilized 0.18 grams of gypsum, and Example 3 utilized 0.18 grams of lime. The gypsum and lime were slightly hydrated with 1 to 2 ml of water to increase dispersion upon introduction to the base solution. After the calcium source was added, agitation was thoroughly applied using a spatula. Another batch of base solution was prepared and split into 115.9 ml volumes. Examples 4 and 5 utilized 115.9 ml of base solution. These examples utilized the same concentrations as Examples 1 and 2 respectively however, these examples were placed in a hot water bath set at 120° F. for 24 hours. The volumetric concentration of materials for crosslinking and exposure temperatures are set forth in Table I below:

TABLE I

| | | Sodium | | | |
|---|---|---|---|---|---|
| | | Alginate | | | Calcium |
| Ex. | | Solution | Gypsum | Lime | Content of |
| No. | Temperature, ° F. | (ml) | (ml) | (ml) | Solution (ml) |
| 1 | Ambient & | 0.73 | 0.04 | — | 0.009 |
| | 150 | | | | |
| 2 | Ambient & | 0.73 | 0.06 | — | 0.0140 |
| | 150 | | | | |
| 3 | Ambient & | 0.73 | — | 0.07 | 0.0379 |
| | 120 | | | | |
| 4 | 120 & | 0.73 | 0.04 | — | 0.009 |
| | Ambient | | | | |
| 5 | 120 & | 0.73 | 0.06 | — | 0.0140 |
| | Ambient | | | | |

Upon mixing 0.12 grams of gypsum into the base solution in Example 1, gel strings immediately appeared on contact. The gypsum did not appear to fully disperse; instead, it localized into gel strings. After mixing for about 2 hours and 15 minutes, the mixture had thickened but was still composed of small globules. The viscosity of the mixture increased over time. After about 4 hours and 15 minutes, the viscosity of the mixture had increased, and the mixture appeared as a large globule composed of local globules. The mixture remained slightly pourable. After about 20 hours and 15 minutes, the mixture had taken the shape of the container, in this case a sample cup. The mixture did not fall out of the cup upon inverting and maintained an appearance of a large globule with localized globules. The mixture dampened a nitrile glove upon touch. About 45 minutes later after the mixture had set up, the contents of the inverted cup were introduced into a 150° F. hot water bath to observe the impact of heat to the crosslinked structure. After being in the hot water bath for about 6 hours, the mixture was removed. The mixture was more homogenous and stouter, and elasticity appeared to have increased with heat.

The mixture of Example 2 initially set up better than that of Example 1. Example 2 appeared as a multitude of gel strings, rather than what would appear to be a homogenous crosslink. However, Example 2 was more crosslinked than Example 1. Approximately a half hour after mixing, the mixture was setting up into a globule. After mixing for about 2 hours and 15 minutes, the mixture had taken the shape of the containing cup and would not fall out of the cup when the cup was inverted. The mixture was very viscous. After about 4 hours and 15 minutes, the mixture had become one globule with localized globules. The mixture maintained the shape of the cup and was not pourable. After about 20 hours and 15 minutes, the mixture was a globule with localized globules. The mixture had become stiffer and could still dampen a nitrile glove. After about 15 minutes, the contents of the inverted cup were introduced into a 150° F. hot water bath. After being in the hot water bath for about 6 hours, the mixture was removed. The mixture had become increasingly homogenous and stout. The increase in elasticity was noted to be greater than that of Examples 4 and 5.

In Example 3, about 0.18 grams of lime was hydrated with 1 to 2 ml of water and introduced to the base solution. The lime isolated to form three gel strings, approximately one inch in length. A strong separation was noted between the base solution and the lime. The base solution appeared to form a halo around the lime. After about 2 hours and 15 minutes, no change in the mixture was observed. The mixture was placed in a hot water bath at 120° F. to determine if the lime could be dispersed with heat. Dispersion never occurred and the mixture remained the same.

The same concentration of gypsum and mixing procedure as Example 1 was used in Example 4. However, in Example 4, the mixture was placed in a 120° F. hot water bath after mixing for about 4 hours and 15 minutes. Before placing the mixture into the bath, it was noted that Example 4 had the same properties as Example 1. About 45 minutes later, the mixture had thickened a n d some syneresis could be observed. The mixture was composed of globules and was still pourable. At this point, Example 4 was more homogenous and less chunky when compared to Example 1. After about 20 hours and 15 minutes, significant syneresis was observed. The mixture consisted of a large globule made up of local globules with lots of free water around the globule. The mixture remained pourable and not as tightly crosslinked as Example 1. Example 1 was more elastic than Example 4. After another 3 hours 3 hours and 45 minutes, Example 4 had become more homogenous but still exhibited some syneresis. The mixture remained pourable and appeared to be one globule made up of localized globules. After another 4 hours and forty-five minutes, Example 4 had not yet fully crosslinked and still exhibited some fluidity. The sample was then taken out of the bath. After about 15 hours, the sample had further set up. However, it was not as tightly crosslinked as Example 1 at this time.

The same concentration of gypsum and mixing procedure as Example 2 were used in Example 5. However, in Example 5, the mixture was placed in a 120° F. hot water bath after mixing for 4 hours and 15 minutes. Before placing the mixture into the bath, the mixture had the same properties as that of Example 2 when it was initially mixed. After an additional 5 hours, the mixture was a globule with localized globules, and syneresis was noted but not as much as that seen in Example 4. Example 5 was more homogenous and less chunky than Example 2. After a total of 20 hours and 15 minutes had elapsed, the mixture was noted as having set up in the shape of the cup. However, the mixture did not suspend when turned upside down. The mixture was more crosslinked than that of Example 4. Overall, heat appears to delay set time as both Examples 4 and 5 were not nearly as set as the room temperature mixtures. This is less notable when comparing Example 2 and Example 5. After an additional 4 hours, little change was seen. The mixture was one globule made of localized globules. The mixture did display some elasticity when compressed slightly but began to fail when more compression was applied. After an additional 4 hours and 15 minutes, the mixture had crosslinked slightly more. Example 5 was left at room temperature overnight. It significantly set up more overnight; however, it was not as set as that of Example 2.

The Examples illustrate that heat affects crosslinking. Heat decreases the ability of crosslinking if immediately applied after mixing, but heat increases the ability to crosslink if applied after the crosslink has initialized. Further, gypsum appeared to perform better as a calcium source than lime. Increasing the concentration of gypsum appears to decrease time necessary to crosslink as well as improve the quality of crosslinking. This is attributable to the higher concentration of calcium ions. The amount of lime introduced too many calcium ions and became a sequestered crosslink gel string. Thus, concentration of lime should be decreased to reduce the amount of calcium ions and prevent over-crosslinking.

The methods that may be described above or claimed herein and any other methods which may fall within the scope of the appended claims can be performed in any desired suitable order and are not necessarily limited to any sequence described herein or as may be listed in the appended claims. Further, the methods of the present disclosure do not necessarily require use of the particular embodiments shown and described herein, but are equally applicable with any other suitable structure, form and configuration of components.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of appended claims. Thus, all matter herein set forth should be interpreted as illustrative, and the scope of the disclosure and the appended claims should not be limited to the embodiments described and shown herein.

What is claimed is:

1. A method comprising:
forming a fluid barrier from the wellbore into the formation with crosslinked alginate; and
reducing fluid loss from a wellbore into a subterranean formation.

2. The method of claim 1 further comprising:
reacting alginic acid or sodium alginate and an alkaline earth metal to form the crosslinked alginate.

3. The method of claim 2 wherein the reacting step occurs in the wellbore.

4. The method of claim 2, wherein the alkaline earth metal is encapsulated to delay formation of the crosslinked alginate.

5. A method for prevent or reducing loss of fluids into flow passages of a subterranean formation penetrated by a well during drilling, completion, cementing or workover operations comprising:
blocking the flow passages with a gel comprising crosslinked alginate.

6. The method of claim 5, wherein the crosslinked alginate is a reaction product of alginic acid or sodium alginate and an alkaline earth containing crosslinking agent.

7. The method of claim 6, wherein the alkaline earth of the alkaline earth containing crosslinking agent is calcium or magnesium.

8. The method of claim 6, wherein the crosslinked agent is lime or gypsum.

9. The method of claim 5, wherein the crosslinked alginate is formed by crosslinking sodium alginate with the calcium containing crosslinking agent.

10. The method of claim 9, wherein the molar ratio of calcium ions to sodium ions in the crosslinked sodium alginate is greater than 2:1.

11. The method of claim 1, wherein the crosslinked alginate is pumped into the well and further wherein the crosslinked alginate is viscosified in-situ to reduce the fluid loss.

12. The method of claim 5, further comprising:
providing the crosslinked alginate to an oil-based or water-based fluid loss pill; and
pumping the fluid loss pill with the crosslinked alginate the well.

13. The method of claim 5, further comprising:
pumping alginic acid or sodium alginate and an alkaline earth metal in the well to firm the crosslinked alginate, wherein the crosslinked alginate is formed in-situ.

14. A method comprising:
pumping alginic acid or sodium alginate into a wellbore penetrating a subterranean formation;
pumping a water-soluble alkaline earth containing crosslinking agent into the wellbore;
forming a viscous gel from the reaction of the alginic acid or sodium alginate with the crosslinking agent; and
forming a fluid-impermeable barrier on the surface of the formation with the viscous gel.

15. The method of claim 14, wherein the alkaline earth of the alkaline earth containing crosslinking agent is calcium or magnesium.

16. The method of claim 14, wherein the crosslinking agent is encapsulated.

17. The method of claim 14, wherein the alginic acid or sodium alginate is pumped separately from the crosslinking agent.

18. The method of claim 14 further comprising:
mixing the alginic acid or sodium alginate with the crosslinking agent prior to pumping into the wellbore.

19. The method of claim 14 wherein the crosslinking agent is encapsulated to delay reaction with the alginic acid or sodium alginate.

20. The method of claim 14 further comprising:
pumping a gel breaker or acid wash into the wellbore to contact the crosslinked alginate after the crosslinked alginate has been pumped or formed in the formation.
